(19) United States
(12) Patent Application Publication
(10) Pub. No.: US 2025/0201133 A1
(43) Pub. Date: Jun. 19, 2025

(54) METHOD AND APPARATUS FOR DETECT AND AVOID MECHANISMS FOR UNMANNED AERIAL SYSTEM

(71) Applicant: INTERDIGITAL PATENT HOLDINGS, INC., Wilmington, DE (US)

(72) Inventors: Abbas Taimoor, Sainte-Julie (CA); Guanzhou Wang, Brossard (CA); Atle Monrad, Froland (NO); Samir Ferdi, Kirkland (CA)

(73) Assignee: INTERDIGITAL PATENT HOLDINGS, INC., Wilmington, DE (US)

(21) Appl. No.: 18/852,298

(22) PCT Filed: Mar. 24, 2023
(86) PCT No.: PCT/US2023/016303

§ 371 Date: Sep. 27, 2024

Related U.S. Application Data
(60) Provisional application No. 63/324,360, filed on Mar. 28, 2022.

(51) Int. Cl. G08G 5/34; G08G 5/57; G08G 5/80; H04W 4/029; H04W 4/40; H04W 92/18

(52) U.S. Cl. CPC G08G 5/34; G08G 5/57; G08G 5/80; H04W 4/029; H04W 4/40; H04W 92/18

(57) ABSTRACT

A method performed by a wireless transmit/receive unit (WTRU) implemented in a first unmanned aerial vehicle (UAV1) includes registering detect and avoid (DAA) capability in a registration message transmitted by the first UAV to an unmanned aerial system (UAS) service supplier (USS), detecting a flight path conflict with a second UAV (UAV2), selecting a unicast or broadcast communication mode with the UAV2, transmitting to the UAV2 the DAA capability of the UAV1 and a deconfliction message based on the selected communication mode, and avoiding a collision by executing a trajectory correction.

### FIELD

This disclosure pertains to methods and apparatus for Detect and Avoid (DAA) Mechanisms for Unmanned Aerial System (UAS).

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram illustrating a reference architecture for supporting Unmanned (Uncrewed) Aerial System (UAS) service in 5GC/EPC according to an embodiment;

FIG. 3 is a block diagram illustrating a UAS application layer functional model according to an embodiment;

FIG. 4 is a signaling diagram illustrating coordinated conflict resolution between Unmanned (Uncrewed) Aerial Vehicles (UAVs) according to an embodiment;

FIG. 5 is a signaling diagram illustrating conflict resolution with UAS Service Supplier (USS) assistance according to an embodiment;

FIG. 6 is a block diagram illustrating network triggered conflict alert and resolution according to an embodiment;

FIG. 7 is a signaling diagram illustrating collision monitoring for all UAVs in conflict resolution zones (CRZs) according to an embodiment;

FIG. 8 is a signaling diagram illustrating USS-requested conflict and collision monitoring according to an embodiment; and

FIG. 9 is a signaling diagram illustrating procedures for UAV Application Enabling (UAE) support for DAA operations according to an embodiment.

### DETAILED DESCRIPTION

### 1 INTRODUCTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### 2 EXAMPLE COMMUNICATION SYSTEMS

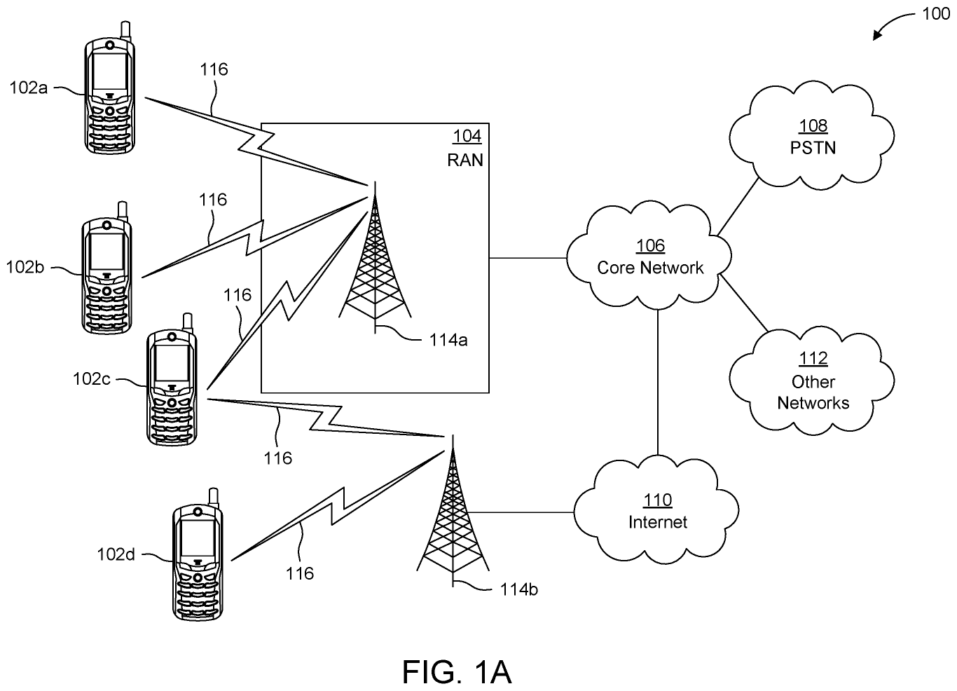

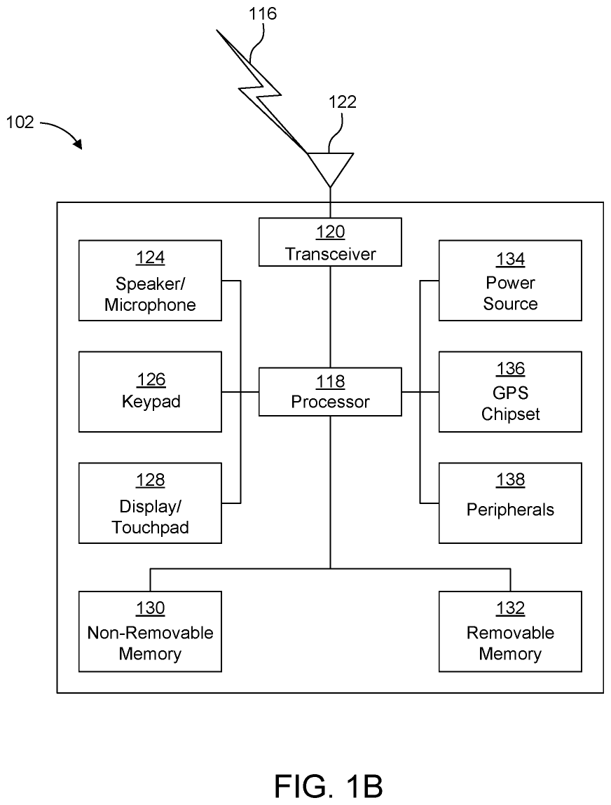

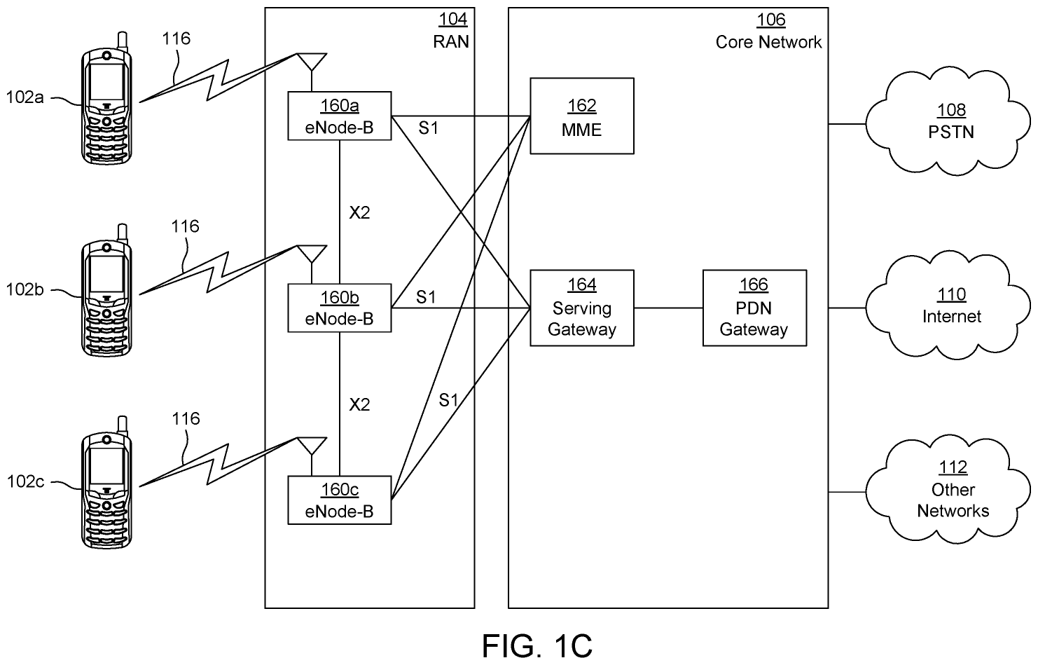

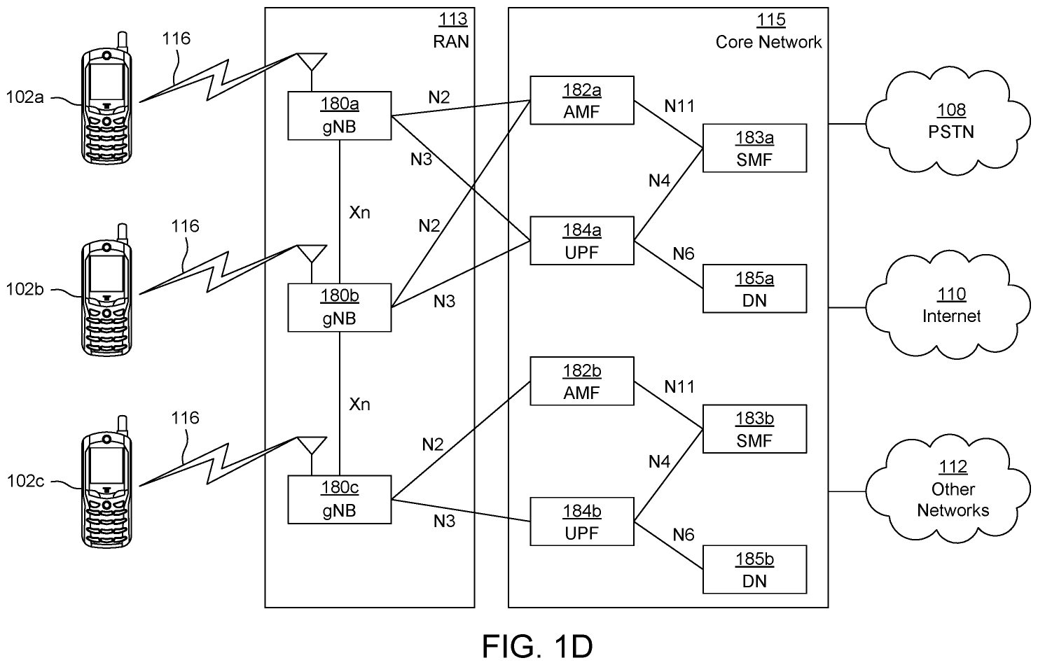

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFi), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802. 11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF a82a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### 3 METHODS AND APPARATUS FOR DETECT AND AVOID (DAA) FOR UNMANNED (UNCREWED) AERIAL SYSTEM (UAS)

### 3.1 Legacy Systems

### 3.1.1 3GPP Rel-17 System Architecture for UAS Connectivity, Identification and Tracking

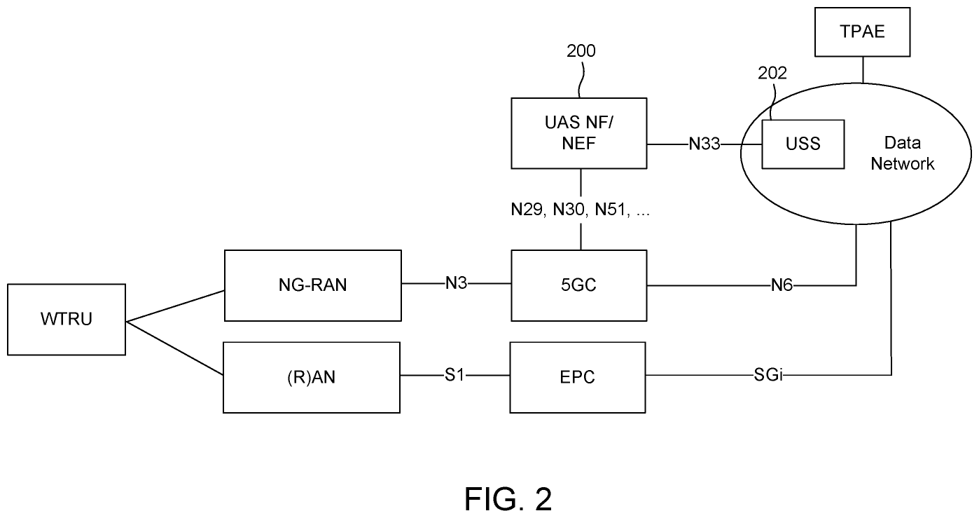

3GPP Release 17 has supported UAS connectivity, identification and tracking functionalities and new specifications for stage 2 [1], and stage 3 [2] are created. As shown in FIG. 2, a new network function, UAS network function (NF), is introduced to support these functionalities. The UAS NF 200 takes part of the roles of the network exposure function (NEF) for exposure of services to the external UAS Service Supplier (USS) 202. It also supports certain UAS specific procedures such as USS UAV Authorization/Authentication (UUAA) and UAS tracking. The UAS NF 200 also stores some UAS context, such as the UUAA result.

### 3.1.2 Multiple USS (Communication Issues Between UAS and USS)

The number of UAVs has been rapidly growing in recent years and the applications enabled by UAVs are expanding into a wide variety of industries. In the UAS Traffic Management (UTM) construct, multiple USSs can operate in the same geographical area for traffic management and deconfliction from other operations of the UAVs; the USS also needs to track the UAVs via a network application program interface (API). Federal Aviation Administration/National Aeronautics and Space Administration (FAA/NASA) has identified several use cases and potential requirements for better capability level provisioning and UAV flight operations resilience in 0. In one of the use cases, the UAS establishes the connection with the USS, shares its location during the flight, and ensures to periodically make the flight updates available to the USS/Universal Transverse Mercator (USS/UTM) network. However, during the flight, the UAS may experience a loss of performance capabilities due to the connection instability and/or the lack of availability at the USS level. For example, such loss may occur when the USS reaches its maximum capacity of serving the possible number of UAVs (traffic management) and can no longer support any additional new UAVs. An explicit intent of having multiple USS also arises in case of operational cost constraints, where a particular USS is more equipped/suitable for certain mission/UAV types (e.g., within a specific area).

### 3.1.3 UAV Application Enabling (UAE) Framework

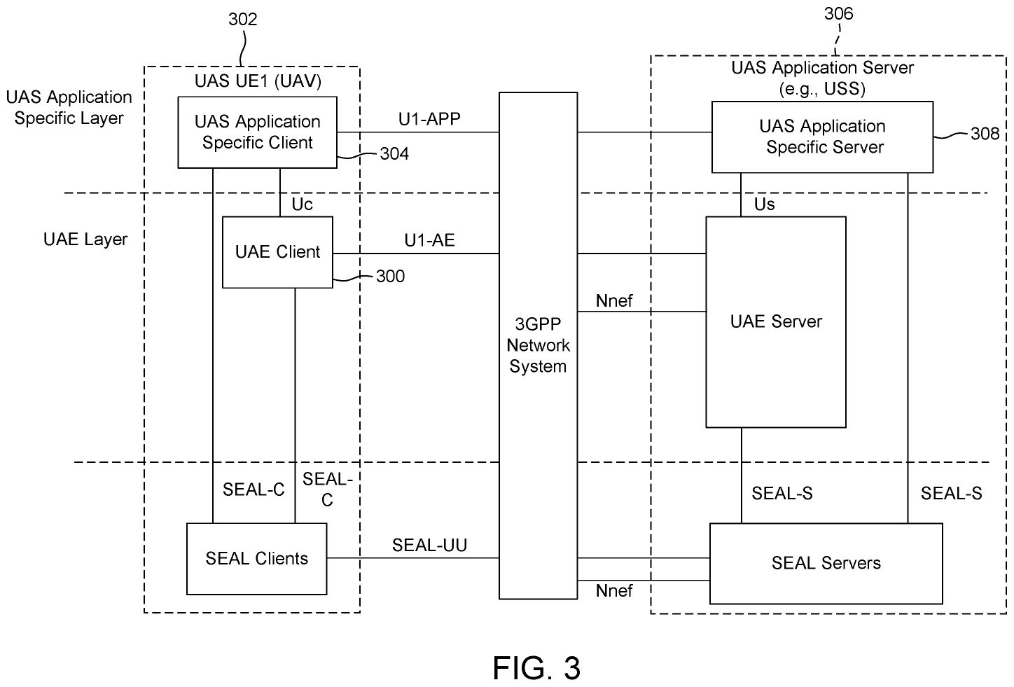

3GPP SA6 has specified a framework to provide support for UAV applications 0. A simplified UAS application layer functional model is illustrated in FIG. 3. A UAE client 300 that resides in the WTRU 302 provides an API to a UAS client application 304 and interface with a UAE server 306 which provides an API to a UAS server application 308 (e.g., USS). UAE server 306 may also interface with the 5GC directly via Network Exposure Function (NEF) API or via Service Enabler Architecture Layer (SEAL) services.

### 3.1.4 Detect and Avoid

23.700-58 “Study of further architecture enhancements for uncrewed aerial systems and urban air mobility” v0.1.0 focuses on the support of detect and avoid mechanisms in the 3GPP system, based on requirements for DAA defined in 3GPP TS 22. 125 “Unmanned Aerial System (UAS) support in 3GPP” v17.5.0 TS 22.125. Such requirements include a capability for UAVs to be able to use direct communications for the purpose of short-range collision avoidance. Aspects such as architectural modifications with respect to the current solutions using PC5 (e.g., ProSe, C-V2X) support direct UAV to UAV communication for the purpose of DAA are considered.

DAA is considered one of the essential features to enable safe BVLOS UAV operations. DAA security in particular for safety-critical DAA is to be ensured 0.

### 3.2 Issues Arising in Legacy Systems

When flying close to each other, UAVs have a possibility of collision, unless their flight path is managed actively or passively to mitigate a potential collision. UAVs may be able to perform local collision detection and avoidance (DAA) operations (e.g., with application layer level logic, with the help of onboard sensors such as cameras or position sensors). However, such sensors can only detect collision when the other UAV is in direct line-of-sight (LOS). For the scenarios beyond visual LOS (BVLOS) it may not work. Additionally, for those cases when the onboard sensors and location sensors accuracy is a question, all the UAVs may not fulfill the requirements for accuracy and reliability (e.g., due to inaccurate GNSS module measurement); thus other UAVs may not rely on the reported/broadcast position estimates. In such scenarios where the UAV reported location, speed, etc. may not be reliable or trusted, it may be desirable for a more global/central support for DAA application by the system to complement UAV local DAA support. The solutions should aim at covering the scenarios where the UAV are in and out of coverage.

With regards to DAA security, DAA data flows in local (e.g., broadcast) or network DAA communications that are safety-critical may be authenticated/authorized. Without the proper security protection mechanisms, an adversary may potentially interfere with UAS operations (e.g., cause a UAS to be rerouted in an unsafe way) for example by spoofing or replay of DAA data flows.

Detect and avoid (DAA) for collision avoidance of UAVs is not yet supported in the standards [1] and [2], and to support the DAA for UAVs the following issues need to be addressed:
How to enable the 5G system to support DAA?
How to resolve or avoid a potential collision? For example, whether and how to adopt, and update flight path based on the anticipated collision warnings for collision avoidance?
   Whether the UAVs are required to communicate directly over the PC5?
   What would trigger such a direct communication (Broadcast/Unicast/Group Cast) between the UAVs?
Whether and How network assistance for DAA can be performed?
What aspects for DAA security may be implemented for safety-critical DAA operations (for local or network DAA communications)?

### 3.3 Embodiment

### 3.3.1 High-Level

A UAV may locally detect the presence of other UAVs with the help of on-board sensors and cameras. If a possibility for collision is detected, the UAV may change its flight path or make small adjustments to avert any imminent danger of collision. Without coordination between the UAVs, this may be driven locally by the UAV (e.g., based on decision and actions triggered at application level).

In this disclosure, proposed support for the DAA procedure may be accomplished by enabling direct communication between the UAVs and/or with the network assistance for collision detection and conflict resolution. The disclosed systems and methods may or may not involve coordinated maneuvers of the UAVs. A high-level technique of the network assisted DAA for UAV detection and conflict resolution is discussed below.

### 3.3.1.1 Collision Detection and Conflict Resolution

Collision detection may work on three levels, proximity, short range and long range as follows,

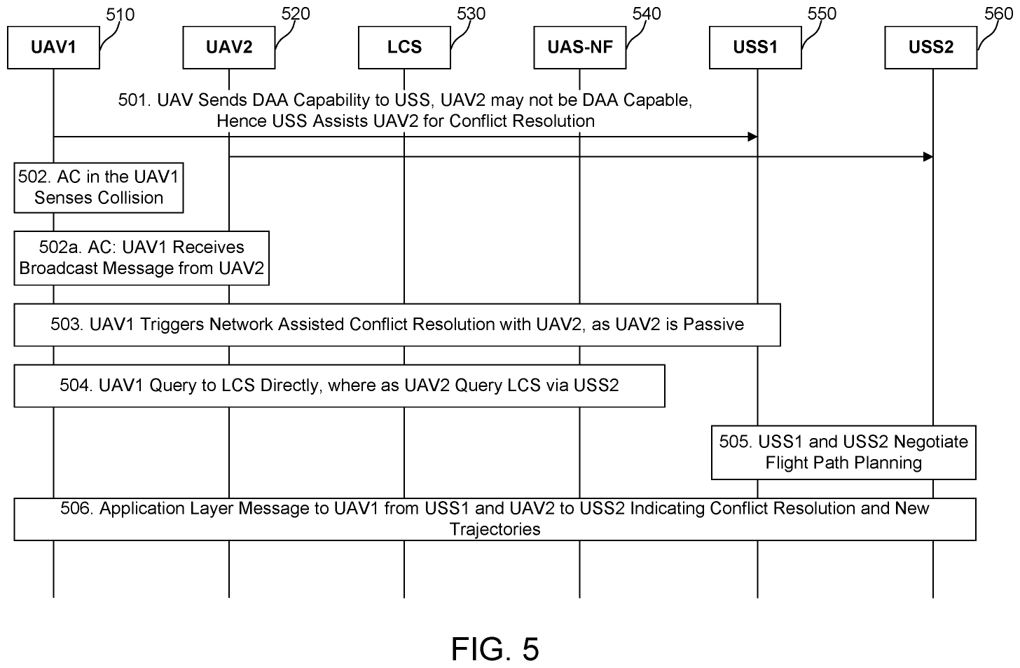

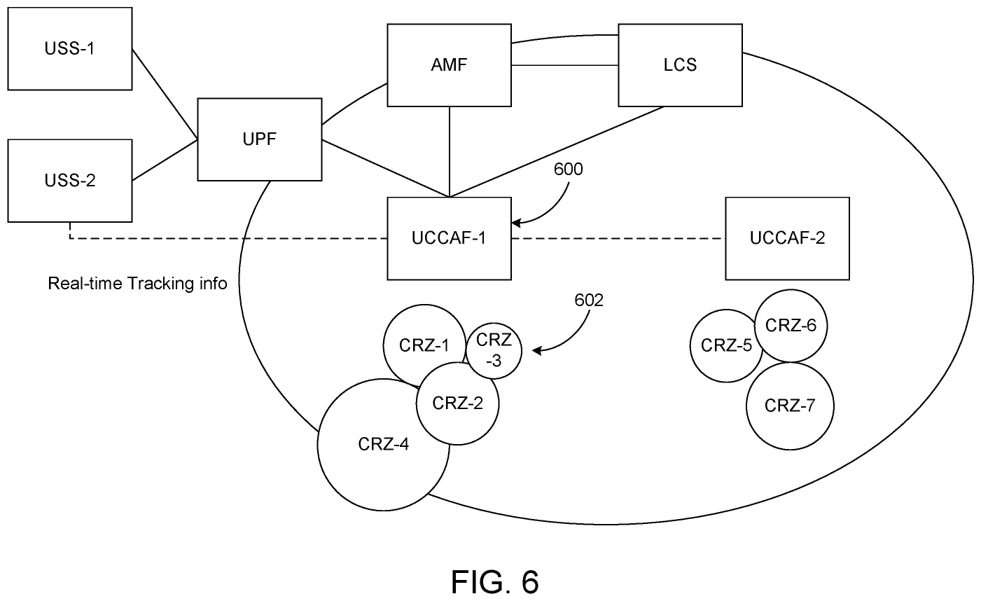

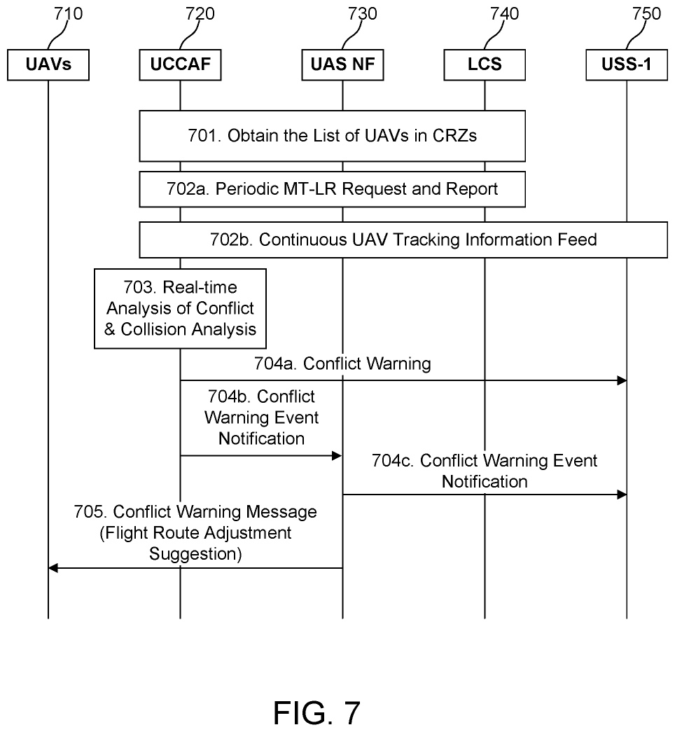

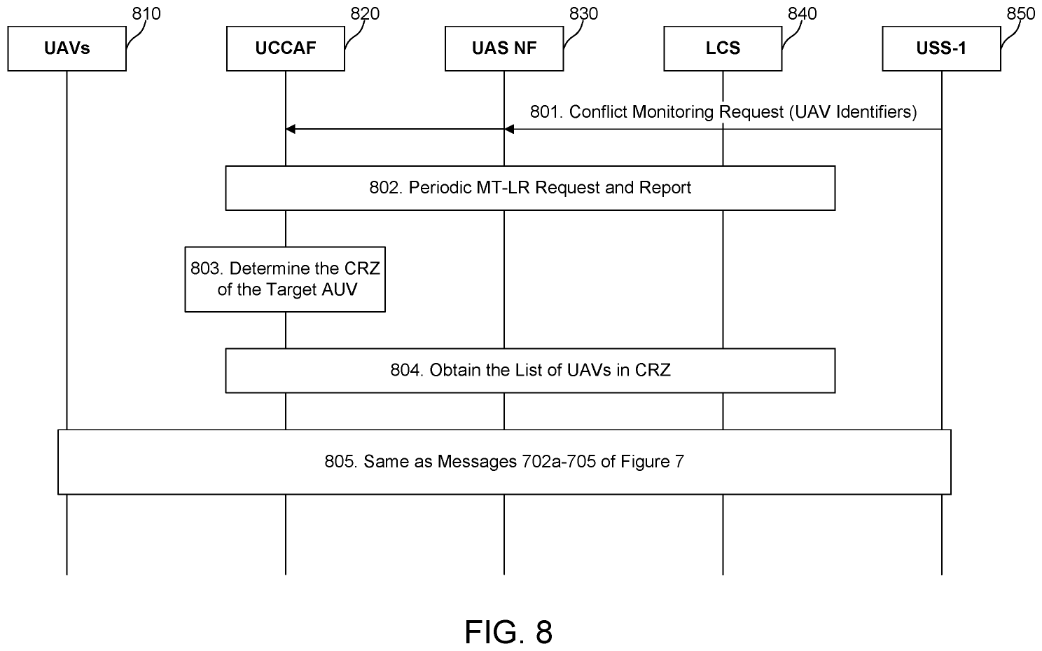

1. Level 1: Proximity within a few meters:
a. Active UAVs may engage in the following exemplary DAA protocol:
   i. Collision detection is possible locally by the UAV if the UAV has the capability.
   ii. The UAV may broadcast an identity, its mobility information (e.g., speed, direction, and location) to the nearby UAVs and include its DAA capability. As part of its DAA capabilities, the UAV may support different modes or levels of collision detection/resolution. The UAV may determine to perform local (using local DAA protocol with other UAVs) and/or central (USS and/or network assisted resolution) collision resolution. The determination may be based on a provisioned DAA policy as described in greater detail below with reference to FIGS. 6 and 7.
   iii. The UAV may include additional information, such as onboard camera, radar, and/or other safety features, as part of its DAA capability.
   iv. The UAV may detect a collision at the application layer, may receive DAA capability indications in the broadcast from other UAVs, and may trigger a direct communication request over PC5 to the lower layers (broadcast or unicast) on the condition that the UAV receives other UAVs indications of DAA capability.
      1. The broadcast may include one DAA capability indication, collision detection alert(s), civilian aviation level authority (CAA)-level UAV IDs of participating UAVs (e.g., UAV sensed in proximity), trajectory correction information (e.g., UAV intended new direction and/or speed to avoid the collision).
      2. The broadcast may include traffic conflict resolved alert(s) and/or CAA-level UAV IDs of participating UAVs from the receiving UAV.
      3. The UAV may use unicast communication with the other UAV. A unicast link may be established when a potential collision is detected, and the unicast link may be disconnected when the collision situation is resolved. To setup the unicast link, the UAV may send a Direct Connection Request (DCR) message with a Service Info parameter identifying a DAA service (e.g., using a standardized DAA service name). The Target User Info may be set to the UAV identity of the other UAV, as received from a prior received message (as in 1). If multiple other UAVs are involved, the Target User Info may not be set. The other UAV(s) may reply with a Direct Connection Accept (DCA) when matching the Service and/or Target User info. The DCR may include DAA policy information. A DAA policy may be transported in an application generic container DAA_info. The DAA policy may indicate the preferred/supported mode of DAA (e.g., local DAA: ON/OFF, central DAA: ON/OFF). The DAA policy may be based on a provisioned policy and the collision context. For example, if more than 2 UAVs are involved in a traffic conflict situation, the UAVs may select a central DAA resolution mechanism. If a UAV is in or out of coverage it may select a local confliction resolution mechanism. The message may include the intended trajectory correction information or that information may be exchanged in subsequent messages after link establishment and based on agreed DAA policy. The other UAVs may reply with a DCA confirming an accepted DAA policy (e.g., local and/or central: ON/OFF), acceptance of a new trajectory, and/or conflict resolution.
   v. The UAV may detect a collision at the application layer and may request an accurate location information and trajectory information, from the LCS, about the UAV itself and the other UAV.
   vi. The UAV may detect a collision at the application layer, inform the USS about the anticipated collision, including the other UAV's CAA-level UAV ID, location info (e.g., current location and time, flight route information, and/or current speed), its DAA capability status, the USS address it is connected to, etc.
   vii. The UAV layer may perform RAT selection respectively, when the UAV requests the lower layers to perform any of the above actions.
b. Passive UAVs (e.g., legacy UAVs that do not support the DAA protocol above) Note: For passive UAVs, as long as other UAVs belong to the same USS, then the USS can detect collision and resolve the conflict. The following procedure assumes when potential collision is detected between the UAVs that they belong to different USSs.
   i. The UAV may send information about nearby UAVs, as received, to the USS, including the other UAV's CAA-level UAV ID, location info (current location and time, flight route information, and/or current speed), its DAA capability status, the USS address, etc.
   ii. The UAV may receive flight path corrections and/or adjustments from the USS.
c. USS
   i. The USS may request location information about the UAVs connected to the USS.
   ii. The USS may request location information about the UAVs connected to other USSs.
   iii. The USS may inform other USSs about its own UAVs in the area where a potential collision was detected with one of the UAVs belonging to the other USSs.
      Level 2: Short range within a couple of hundred meters, and Level 3: long range along the whole flight path, where the collision detection may be coordinated by the USS. It may be based on the route plan and anticipated trajectories. Level 2 and Level 3 are described in greater detail below with reference to FIGS. 5-8.

### 3.3.2 Coordinated Conflict Resolution Between the UAVS

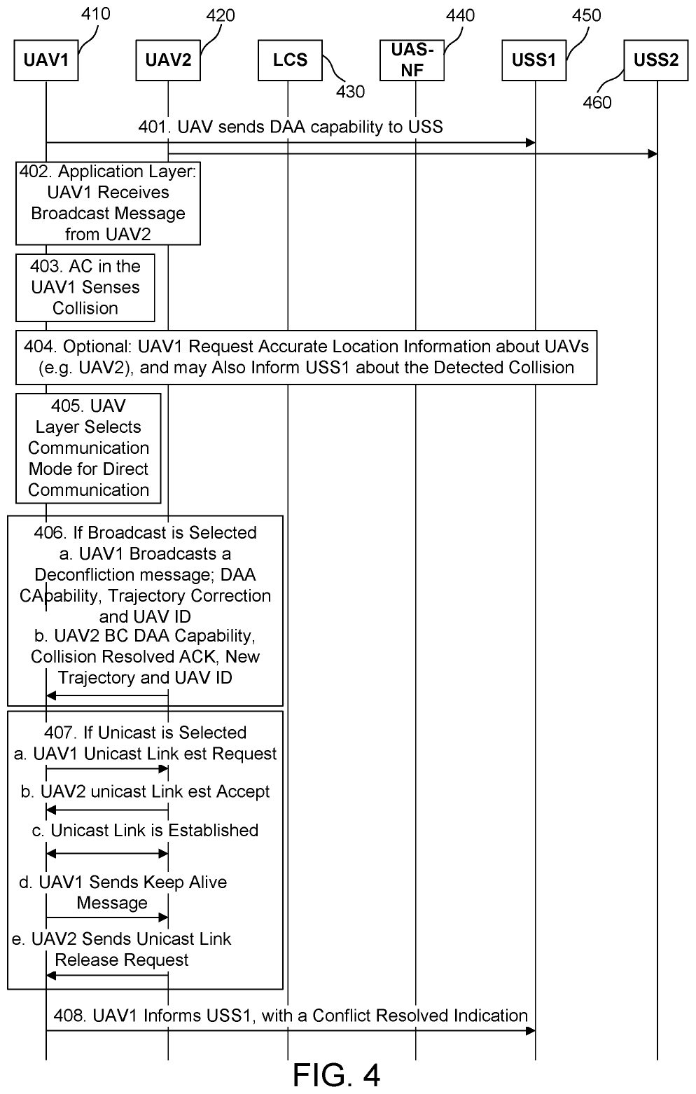

In one embodiment, both UAVs may be active and may be capable of locally deciding to avoid the conflict, without involvement of the USS. Such UAVs may be capable of coordinated communication over the PC5 (unicast or broadcast) link, and may be called DAA capable UAVs that include DAA capability in the broadcast messages. FIG. 4 depicts steps of related procedures as follow.
1. UAV1 and UAV2 may send their DAA capability to the USS when performing initial registration or authorization with the USS. UAV may include additional information such as an identifier (e.g., CAA level UAV ID), onboard camera, and/or other safety features as part of DAA capability.
2. Application layer-UAV1 may receive broadcast messages from other UAVs, e.g., UAV2, that may include, e.g., CAA-level UAV ID, UAV2's USS address, velocity, heading direction, and/or position. If the application in the UAV1 detects a collision, it may trigger collision avoidance/conflict resolution using the cooperative communication between the UAVs.
3. UAV1's application client, if DAA capable, in the UAV1 may sense a conflict, based on the broadcast messages received from the other UAVs, e.g., UAV2, and compare it with its own trajectory and location.
4. Optionally, UAV1 may request accurate location information (including its own ID, and peer WTRUs' IDs) of UAV2 from location services (LCS) via the USS. It may be possible for UAV1 to request this information directly, if UAV1 is pre-authorized for such operation and the USS has informed the LCS about such authorization including user ID, e.g., GPSI, SUPI or GUTI, of the UAV1. At this step, UAV1 may inform the USS1 about the detected collision with UAV 2 and include information such as UAV2.
   a. Alternatively, if the LCS is not available, the UAV may also be able to work without LCS/USS connection to support scenarios where the UAV is out of coverage. The UAV in that case may rely only on the position estimates from the onboard sensors.
5. UAV1 may trigger a direct communication request over PC5 (broadcast or unicast) to the lower layers. The UAV layer in the middle may perform communication mode selection based on the input received from the application layer, i.e., PC5 broadcast or unicast for direct communication or Uu for via USS.
6. If broadcast is selected for direct communication:
   a. UAV1 may broadcast a message, e.g., safety message which may be an application layer message, and may include DAA capability, collision detection alert, CAA-level UAV IDs of its own and the other UAV, and/or trajectory correction information to avoid collision. The message may include frequency of subsequent messages to be exchanged between UAVs for traffic conflict resolution and/or position/trajectory monitoring.
   b. UAV2 may broadcast a message and may include DAA capability, conflict resolved alert, and/or CAA-level UAV IDs of participating UAVs from the receiving UAV.
   c. UAV1 and UAV2 may transmit periodically one or more broadcast messages, including updated real time position/trajectory information from the time the traffic conflict is detected (a) and signalled until its final resolution (b).
7. If unicast is selected for direct communication:
   a. UAV1, without 5G PC5 ProSe discovery, may initiate a PC5 link establishment request and may include DAA capability, DAA resolution policy (e.g., local and/or central), collision detection alert, and/or WTRU IDs for UAV1 and UAV2.
   b. UAV2, may receive and responds to the request from UAV1, as a PC5 link establishment response, and may include DAA capability, agreed DAA resolution policy, collision detection alert acknowledged, and/or WTRU IDs for UAV1 and UAV2.
   c. A unicast link may be established and a path negotiated between UAVs, e.g., UAV1 and UAV2, for conflict resolution.
   d. UAVs may exchange PC5-s messages based on agreed DAA policy, e.g., UAV1 may send a keep alive message to UAV2 carrying an intended or new trajectory, real time position/speed, and/or end of collision indication. If central resolution is performed, the UAV may receive the new trajectory information from the USS and inform other UAVs of the central resolution status.
   e. A unicast link disconnection request may be initiated as soon as conflict is resolved, which may be initiated by either of the UAV1 or UAV2, i.e. UAV2 in this case.
8. Optionally, UAV1 may inform the USS1 about the conflict resolution with UAV2, where USS1 may coordinate with USS2 for long-term conflict resolution as described in greater detail below with reference to FIGS. 6-8.
   3.3.3 Conflict Resolution with USS Assistance

In another embodiment, one or more UAVs may be inactive (passive) and may not detect and avoid collision locally. For such a UAV, the USS may perform DAA based on the tracked trajectories of the drones and possibly comparing them with the information received from the other UAVs directly or via their USSs. Such a UAV may be called a DAA incapable UAV, and may not broadcast DAA capability in their broadcast messages.

Referring to FIG. 5, steps of a procedure for conflict resolution with USS assistance are described as follows.
1. UAV1 and UAV2 may send their DAA capability (if DAA capable) to the USS when performing initial registration or authorization with the USS. A UAV may include additional information such as an identifier (e.g., CAA level UAV ID), onboard camera, or other safety features as part of the DAA capability. In this example, at least one UAV may not be DAA capable.
2. Application layer—UAV1 may detect a collision with the help of onboard sensors. If the application in the UAV1 detects a collision, it may trigger collision avoidance/conflict resolution, Or;
   a. Application layer—UAV1's application client may sense a conflict, based on the broadcast messages received from the other UAVs, e.g., UAV2, and compare it with its own trajectory and location.
3. If the application in the UAV detects a collision, it may trigger the network assisted avoidance/conflict resolution.
   a. If the UAV is active (has DAA capability) it may inform the USS about the anticipated collision, including other UAVs' CAA-level UAV ID, location info (current location and time, flight route information, and/or current speed), the other UAVs' DAA capability status, and/or the USS address.
   b. Alternatively, if the UAV is passive (has no DAA capability) then it may pass the information to the USS as received, including other UAVs' CAA-level UAV ID, location info (current location and time, flight route information, and/or current speed), other UAVs' DAA capability status, and/or the USS address.
4. UAVs may already be reporting their locations to LCS, which improves the location estimation and keeps track of the trajectory, and/or the LCS itself may be tracking their locations and trajectories.
   a. If the UAV is active (has DAA capability), the UAV, upon detecting a potential collision, may query the LCS (including its own ID and/or peer WTRUs' IDs) to request accurate location and trajectory estimates from the LCS and the LCS may send this information to the relevant USS.
   b. Alternatively, if the UAV is passive (e.g., has no DAA capability), then the USS may query the LCS to request accurate location and trajectory estimates from the LCS for the other UAVs directly and/or via the UAV's USS.
5. USS1 may interact with USS2 and negotiate either a short term or long term flight plan for the conflicting UAVs, depending upon whether the destination is known or not, to avoid future collisions between the particular two UAVs.
6. An application message may be sent from the USS to a UAV with a suggestion of correction in the flight path for collision avoidance.

### 3.3.4 Network-Triggered Conflict Alert and Resolution

One or multiple UAV Conflict & Collision Analysis Function (UCCAF) may be supported in 5GC. The UCCAF may provide DAA-as-a-Service to its users (e.g., USS network, UAV operators, CAA, etc.). The major roles of the UCCAF include one or more of the following:
i. The UCCAF may track all the UAVs in one or more geographical Conflict Resolution Zones (CRZ) and monitors the mobility information (location, altitude, speed, direction, etc.) of the UAVs in the zones. The zones can be planned according to the density of UAV flights. For example, dense flight areas (e.g., above a metropolitan area) may have smaller zones and non-dense flight areas may have larger zones. The UCCAF may utilize the existing UAV tracking procedures (5.3 in 3GPP TS 23.256, “Support of Uncrewed Aerial Systems (UAS) connectivity, identification and tracking”, v17.0.0) for the list of UAVs in the zones for which it is responsible.
ii. The UCCAF may retrieve real-time mobility information from the LCS or USSs and analyse any potential conflict or collision possibility in the zones for which it is responsible. The UCCAF may act as a LCS client and retrieve the mobility information from the LCS using existing procedures (e.g., MT-LR procedure in TS 23.273) or it may be part of a GMLC function where the WTRU/UAV's mobility information is readily available. The UCCAF may interact with multiple USSs for feeding of UAV's real-time mobility information via web interfaces or via the UAS NF in 5GC. The UCCAF may also be part of the UAS NF. The UCCAF may also be configured with the information (e.g., location, height, etc.) of the high-rise objects (buildings, towers, mountains, etc.) in the zones. The UCCAF may be an AF (e.g., part of or outside USS network) that may interact with one or more networks (e.g., via UAS NF) on behalf of one or more USS.
iii. When the UCCAF determines there is potential conflict or collision risk for one or multiple UAVs, it may trigger the network to send alert/warning messages to the UAVs, their controllers, and/or USSs. The UCCAF may also provide flight route adjustment or manoeuvre suggestions directly to the WTRU via the network if it is authorized to do so.

Multiple UCCAFs inside a PLMN may interact and exchange information with each other when needed. In the areas that may be covered by multiple PLMNs UCCAFs in one PLMN may interact with UCCAFs in other PLMNs to determine and resolve the conflicting risk.

Referring to FIG. 6, the UCCAF 600 may by default provide conflict monitoring and resolution services for all the UAVs in the zones for which it is responsible. Alternatively, it may provide such services for one or multiple UAVs upon the request of a USS or UAS NF. In the former case, the UCCAF may periodically receive the presence info of the UAVs in its CRZs 602 and monitor the mobility/tacking info of these UAVs. In the latter case, it may to determine the CRZ that the target UAV is in, which may be changing along the UAV's flight route, and monitor the mobility/tracking info of all the UAVs in that particular CRZ.

FIG. 7 depicts steps of a procedure in which the UCCAF monitors collision risk for all UAVs in its CRZs as follows.
Step 1. The UCCAF may obtain a list of UAVs in its CRZs by using the similar procedure described in 6.3.4 of TS 23.256. The UCCAF may initiate the UAV list request instead of the USS and may provide the geographic information of its CRZs to the UAS NF. If the CAA-Level UAV IDs are not received in the list, the UCCAF may further query the UAS NF for the corresponding CAA-Level UAV IDs.
Step 2a. After obtaining the list of UAVs in the CRZs, the UCCAF, acting as a LCS client, may use the periodic MT-LR location report procedure as defined in 6.3.1 or TS 23.273 to receive the periodic location information of the UAVs.
Step 2b. Alternatively, the UCCAF may directly retrieve real-time tracking information from the USSs that are responsible for the UAVs, e.g., via Web interface.
Step 3. According to the received location/tracking information, the UCCAF may perform real-time intelligent analysis of the potential conflict & collision risk for all the UAVs in the CRZs. The UCCAF may be configured with a “minimum clearance” parameter to determine the risk.
Step 4a. If the UCCAF determines that one or multiple groups WTRUs may be involed in potential conflict or collision, it may send Conflict Warning messages to the responsible USSs, e.g., via Web interface, that are responsible for those UAVs in risk. The UCCAF may indicate the identifier of the UAVs in risk and/or the estimated time and position of the potential conflict or collision. If may also suggest the flight route adjustment or UAV maneuver that may unlikely lead to another conflict/collision. Based on the received warning and/or suggestion, the USS may inform the UAVs and/or their UAV-Cs of the warning and suggested flight route update and maneuver.
Step 4b. Alternatively, the UCCAF may use the network event exposure mechanism to send the warning event to the USSAF via the UAS NF.

### Step 5.

If the UCCAF and/or UAS NF is configured or authorized to directly warn the UAVs, the UAS NF may send a NAS conflict warning message to the UAVs via the AMF or SMF. The NAS message may also contain the flight route adjustment and/or maneuver suggestion. If the UAV is configured to follow the suggestions directly from the UCCAF/UAS NF, it may take actions accordingly; otherwise, it may report the warning and suggestions back to the USS or its UAV-C and wait for further instructions.

FIG. 8 depicts steps of a procedure that may be applied in the case that the UCCAF monitors collision risk for one or multiple UAVs upon the request of the USS as follows.
Step 1: The USS may send a Conflict Monitoring request to the UCCAF via UAS NF. The USS may provide the target UAV identifiers (e.g. GPSI and/or CAA-Level ID) and its current tracking information. It may also provide a geographical area for the UCCAF to monitor all its UAVs in that area, and it may provide some requirements, such as “minimum clearance” for conflict/collision monitoring. It may further indicate whether a flight route adjustment suggestion is required in case of conflict.
Step 2: The UCCAF may periodically obtain the target UAV's location information from the LCS.
Step 3: The UCCAF may determine which CRZ the WTRU is currently in. It may do this periodically as the UAV changes location along the flight route. If a geographical area to be monitored is provided by the USS, the UCCAF may map it to the CRZs for which it is responsible.
Step 4: The UCCAF may obtain the list of all UAVs inside the same CRZ.
Step 5: The remaining procedures are similar to Step 2-5 in FIG. 7 as described above.

### 3.3.5 DAA Support Using Enhanced UAE

3.3.5.1 UAE client Registration with UAE Server

In a method for DAA support capability registration between a UAE client and the UAE server, the UAE client may send a Registration request to a UAE Server, including DAA capability. The UAE client may indicate UAE client DAA capability and UAE client contextual information (e.g., frequency of broadcasting UAV mobility info (position, direction, and/or speed)). The UAE server may also indicate to the serving USS the UAE server DAA capability and possible UAE server contextual information (e.g., the network area the UAE server can serve for DAA purposes based on network coverage information). The UAE server may perform one or more authentication and authorization checks and may interact with the USS in the process to indicate DAA capabilities and identification information of UAE client/server. The UAE client may receive a Registration response from the UAE server, including a success indication, if a UAE server supports such capability.

3.3.5.2 DAA Management/DAA Configuration

In a method for DAA support enabled at a UAE client upon a request from a USS, the UAE server may receive a DAA management request from a serving USS for managing the DAA. The request may include the UAV (UAE client) identification information and/or DAA configuration parameters/DAA policy. The UAE server may send a response acknowledging support based on UAE client and server support for such capability. The UAE client may receive a DAA configuration request from the UAE server that includes the DAA configuration parameters/DAA policy. The policy may include parameters/rules on whether and how the UAE client may act with respect to detect and/or avoid. For example, the policy may include rules for the UAV to communicate with the USS and/or other UAVs (i.e., for central and/or local flight path conflict resolution) to indicate possible interfering objects based on the policy and/or perform a change of the expected forward path or altitude due to interfering objects. For example, DAA policy rules may apply considering whether the UAV is in-coverage and out-of-coverage of the network. The UAE client may store the DAA configuration parameters and send a DAA support configuration response to the server. The UAE server may send an acknowledgement to the USS that the DAA information is provided to the UAE client. The UAE client/server may use the provided DAA policy to prevent collision while in flight.

### 3.3.5.3 UAE-Layer Assisted DAA

In a method for dynamically changing the current path upon a request from a USS and/or based on UAE client/server configuration due to DAA, the USS, the UAE server, and/or the UAE client may notice that change of expected flight path is needed due to identified objects that may interfere with the UAV and potentially cause dangerous situations. The UAE server may receive a DAA request from a USS. The request may include the UAV (UAE client) identification information and/or actions to take to avoid collision. The UAE server may verify that the request is authorized. The UAE client may receives the DAA request, with actions to take to avoid collision, from the UAE server. The UAE client may act accordingly. Alternatively, the UAE client may initiate the change of flight path based on previously received DAA policy without any external indication (i.e., without an explicit request from the UAE server), e.g., when the UAA policy or UAV internal functionality from the application layer identify abnormalities. The UAE client may send a DAA response to inform the UAE server. The UAE server may update the USS accordingly.

Alternatively, the UAE server may initiate the change of flight path (on behalf of the USS) based on USS provided DAA capabilities and policy. For example, if the UAE server is allowed to initiate change of flight path due to the DAA policy (e.g., after determination by the UAE server that a change of flight path is needed.

### 3.3.5.4 Support for UAE-Layer DAA—Call Flow

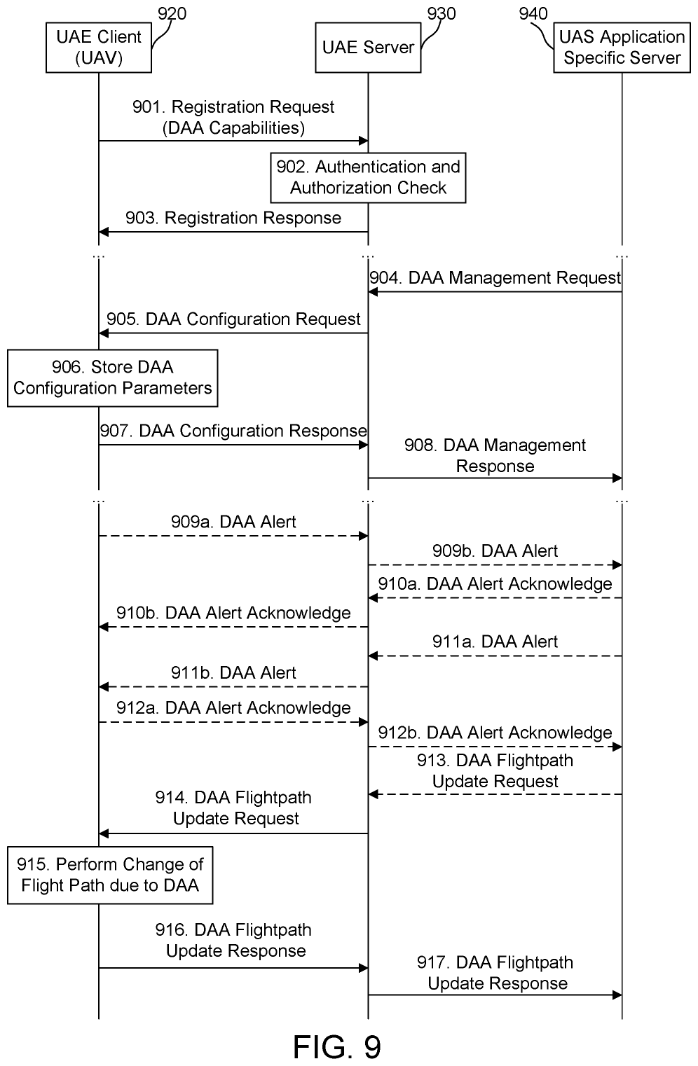

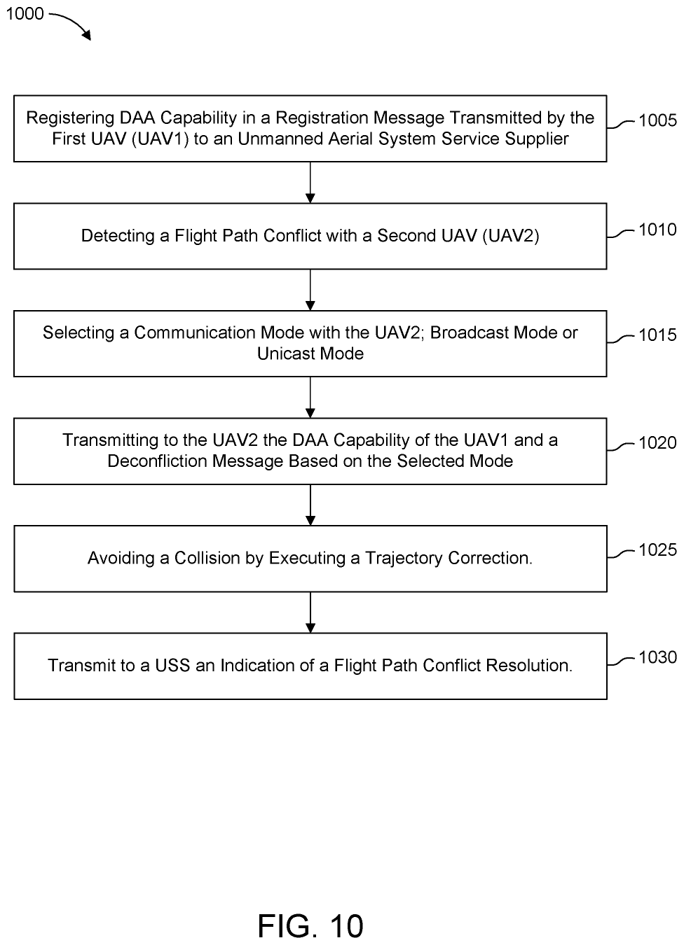

FIG. 9 illustrates the procedures for UAE support for DAA operations as described above. In FIG. 9, steps of the procedures for UAE-layer support for Multi-USS operations are described as follows.
1. The UAE client may send a registration request, to a UAE Server, including an indication of DAA capability.
2. The UAE server may perform authentication and authorization checks and may interact with the USS in the process and to indicate DAA capabilities and identification information of the UAE client.
3. The UAE client may receive a Registration response from the UAE server with an indication of authorization for DAA support.
4. The UAE server may receive a DAA management request from a serving USS for managing the support for DAA. The request may include the UAV (UAE client) identification information and DAA configuration parameters. If the request is to add a configuration, the UAE server may store the configuration parameters associated with the DAA in the UAE client context. If the request is to remove a configuration, the UAE server may check that the configuration is associated with the requesting USS before deleting the configuration from the UAE client context and sending a request to the UAE client.
5. The UAE client may receive the DAA configuration request from the UAE server. The request may be to add or delete the DAA configuration.
6. If the request is to add (respectively delete) a configuration, the UAE client may store (respectively delete) the DAA configuration associated with the USS.
7. The UAE client may send a DAA support configuration response to the server to acknowledge addition/removal of the configuration.
8. The UAE server may send a response to the USS indicating enablement or disablement of DAA capability.
9. The UAE client may send to the UAE server a DAA alert indicating a detected or resolved flight path conflict with one or more UAVs in proximity. The message may include updated trajectory with a cause of DAA. The UAE server may send the DAA alert to the USS.
10. The USS may acknowledge the alert to the UAE client via the UAE server.
11. The UAE server may receive from the USS a DAA flight path update request including UAV identification and new/corrected flight path information. The UAE server may verify that the request is authorized as described above before sending a request for change of flight path to the UAE client.
12. The UAE client may receive a DAA flight path update request from the UAE server.
13. The UAE client may perform change of flight path due to DAA based on a request and/or DAA configuration. The UAE layer may inform the application.
14. The UAE client may sends to the UAE server a DAA flight path update response to indicate a change of flight path. The UAE client may include relevant additional information about the reason for change of flight path and actual new flight path in the message.
15. The UAE server may send to the USS a DAA flight path response to indicate a change of flight path. The UAE server may include relevant additional information about the reason for change of flight path and actual new flight path in the message.

In one embodiment as an alternative solution, step 9 and 10, from the above call flow may be implemented as set forth as below, and also as shown in FIG. 9.
9. The USS may send to the UAE server a DAA alert indicating a detected or resolved flight path conflict with one or more UAVs in proximity. The message may include updated trajectory with a cause of DAA. The UAE server may send the DAA alert to the UAE client.
10. The UAE client may acknowledge the alert to the USS via the UAE server.

### 4 CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### 5 REFERENCES

The following references may have been referred to hereinabove and are incorporated in full herein by reference.
[1] 3GPP TS 23.256, “Support of Uncrewed Aerial Systems (UAS) connectivity, identification and tracking”, v17.0.0
[2] 3GPP TS 24.501 17.4.1
[3] 3GPP S2-2103785, New SID on Study of Further Architecture Enhancement for UAV and UAM-Rel-18
[4] Concept of Operation, v2.0, FEDERAL AVIATION ADMINISTRATION, (Mar. 2, 2020), https://www.faa.gov/uas/research_development/traffic_management/media/UTM_ConOps_v2.pdf
[5] Roche, C., Oakes, S., Bender, K., Magyarits, S. and Homola, J. R., 2018. UTM RTT CWG Concept & Use Cases Package #2.
[6] Hatfield, M., Cahill, C., Webley, P., Garron, J. and Beltran, R., 2020. Integration of Unmanned Aircraft Systems into the National Airspace System-Efforts by the University of Alaska to Support the FAA/NASA UAS Traffic Management Program. Remote Sensing, 12(19), p.3112.
[7] 3GPP TS 23.700-55, “Study on enhanced Application Architecture for UAS applications”, v0.2.0
[8] 3GPP SP-211511, “Study on enhanced architecture for UAS Applications”
[9] 3GPP TS 23.255, “Application layer support for Unmanned Aerial System (UAS)”, v17.2.0
[10] https://www.faa.gov/regulations_policies/rulemaking/committees/documents/media/UAS_BVLOS_ARC_FINAL_REPORT_03102022.pdf

1. A method performed by a wireless transmit/receive unit (WTRU) implemented in a first unmanned aerial vehicle (UAV1), the method comprising:
transmitting a registration request including detect and avoid (DAA) capability of the UAV1 to a UAV application enabling (UAE) server;
receiving a registration response including an indication of authorization for DAA support;
receiving DAA configuration parameters;
storing and/or updating the DAA configuration parameters;
transmitting a DAA configuration response acknowledging the stored and/or updated DAA configuration parameters;
detecting a flight path conflict with a second UAV (UAV2);
transmitting DAA client event information corresponding to the detected flight path conflict;
receiving a DAA alert based on the detected flight path conflict;
transmitting a DAA alert acknowledgement;
receiving a DAA flightpath update request;
changing the flight path based on at least one of the DAA flightpath update request and the DAA configuration parameters; and
transmitting a DAA flightpath update response.

2. The method of claim 1, wherein the registration request includes one or more of an identifier for the UAV1 and a hardware capabilities summary of the UAV1.

3. The method of claim 2, wherein detecting a flight path conflict comprises receiving a broadcast message from the UAV2 and determining from the broadcast message if the UAV1 and the UAV2 have the flight path conflict, and wherein the broadcast message from UAV2 comprises one or more of a UAV2 identifier, a UAV2 velocity, a UAV2 heading direction, or a UAV2 position.

4. (canceled)

5. The method of claim 3, wherein detecting a flight path conflict with UAV2 comprises obtaining location information of one or more of UAV1 and UAV2 using network location services and determining that a flight path conflict exists between UAV1 and UAV2.

6. The method of claim 5, further comprising selecting a communication mode with the UAV2 and selecting a direct communication request over a PC5 link, wherein selecting the communication mode is performed at a UAV application layer.

7. The method of claim 5, wherein further comprising transmitting, to the UAV2, a deconfliction message including one or more of a DAA capability, a collision detection alert, UAV identifiers, and trajectory correction information.

8. The method of claim 7, wherein transmitting to the UAV2 the DAA capability of the UAV1 and the deconfliction message based on a selected communication mode comprises selecting a unicast communication mode wherein UAV1 initiates a PC5 link establishment request, the request comprising UAV1 and UAV2 identifiers, the DAA capability of the UAV1, a DAA resolution policy, a collision detection alert, and trajectory correction information to avoid a collision, and wherein the trajectory correction information is transmitted using a unicast keep alive message.

9. (canceled)

10. The method of claim 8, wherein transmitting to the UAV2 the DAA capability of the UAV1 and the deconfliction message based on the selected communication mode comprises selecting a broadcast communication mode wherein UAV1 broadcasts the UAV1 and UAV2 identifiers, the DAA capability of the UAV1, and trajectory correction information to avoid collision.

11. The method of claim 10, further comprising:
receiving from the UAV2 an indication of one or more of DAA capability, an acknowledgement of collision resolution, and a new trajectory.

12. (canceled)

13. The method of claim 11, wherein the further comprising transmitting an indication of flight path conflict resolution including a new trajectory to the UAV1 for long term flight path correction by considering other UAVs along a flight path of at least one of the UAV1 and the UAV2.

14. A wireless transmit/receive unit (WTRU) in a first unmanned aerial vehicle (UAV1), the WTRU comprising:
processor circuitry; and,
a transceiver configured to:
transmit, to a UAV application enabling (UAE) server, a registration request including detect and avoid (DAA) capability of the UAV1;
receive a registration response including an indication of authorization for DAA support; and
receive DAA configuration parameters;
the processor circuitry configured to store and/or update the DAA configuration parameters;
the transceiver configured to transmit a DAA configuration response; acknowledging the stored and/or updated DAA configuration parameters;
the processor circuitry configured to detect a flight path conflict with a second UAV (UAV2);
the transceiver configured to:
transmit DAA client event information corresponding to the detected flight path conflict;
receive a DAA alert based on the detected flight path conflict;
transmit a DAA alert acknowledgement; and
receive a DAA flightpath update request;
the processor circuitry configured to change the flight path based on at least one of the DAA flightpath update request and the DAA configuration; and
the transceiver configured to transmit a DAA flightpath update response.

15. The WTRU of claim 14, wherein the registration request includes one or more of an identifier for the UAV1 and a hardware capabilities summary of the UAV1.

16. The WTRU of claim 15, wherein the WTRU detects a flight path conflict by receiving a broadcast message from the UAV2 and determines from the broadcast message if the UAV1 and the UAV2 have the flight path conflict, and wherein the broadcast message from the UAV2 comprises one or more of a UAV2 identifier, a UAV2 velocity, a UAV2 heading direction, and a UAV2 position.

17. (canceled)

18. The WTRU of claim 16, wherein the WTRU detects a flight path conflict with UAV2 by obtaining location information of one or more of UAV1 and UAV2 using network location services and determining that a flight path conflict exists between UAV1 and UAV2.

19. The WTRU of claim 18, wherein the transceiver is configured to transmit a direct communication request over a PC5 link to communicate with the UAV2.

20. The WTRU of claim 19, wherein the transceiver is configured to transmit, to the UAV2, a deconfliction message based on selecting a unicast communication mode wherein the UAV1 initiates a PC5 link establishment request, the request comprising UAV1 and UAV2 identifiers, a UAV1 DAA capability, a DAA resolution policy, a collision detection alert, and trajectory correction information to avoid a collision, wherein the trajectory correction information comprises a unicast keep alive message.

21. The WTRU of claim 20, wherein the deconfliction message comprises one or more of a DAA capability, a collision detection alert, UAV identifiers, and trajectory correction information.

22. The WTRU of claim 21, wherein the transceiver is configured transmit, to the UAV2, the DAA capability of the UAV1 and a deconfliction message based on selecting a broadcast communication mode wherein the UAV1 broadcasts the UAV1 and UAV2identifiers, the DAA capability of the UAV1, and trajectory correction information to avoid collision.

23. The WTRU of claim 22, further wherein the transceiver is further configured to receive, from the UAV2, an indication of one or more of DAA capability, an acknowledgement of collision resolution, and a new trajectory.

24. (canceled)

25. The WTRU of claim 23, wherein the transceiver is further configured to transmit an indication of flight path conflict resolution including a new trajectory to the UAV1 for long term flight path correction by considering other UAVs along a flight path of at least one of the UAV1and the UAV2.

26. (canceled)
